(19) United States
(12) Patent Application Publication
(10) Pub. No.: US 2021/0018810 A1
(43) Pub. Date: Jan. 21, 2021

(54) ELECTROCHROMIC DEVICE HAVING COLOR REFLECTANCE AND TRANSMISSION

(71) Applicant: View, Inc., Milpitas, CA (US)

(72) Inventors: Robert T. Rozbicki, Saratoga, CA (US); John Gordon Halbert Mathew, Santa Rosa, CA (US)

(21) Appl. No.: 16/981,600

(22) PCT Filed: Mar. 15, 2019
(86) PCT No.: PCT/US2019/022580

§ 371 Date: Sep. 16, 2020

Related U.S. Application Data
(60) Provisional application No. 62/644,261, filed on Mar. 16, 2018.

(51) Int. Cl. G02F 1/157; G02F 1/153; G02F 1/1524

(52) U.S. Cl. CPC G02F 1/157; G02F 2001/1536; G02F 1/1524; G02F 1/1533

(57) ABSTRACT

The disclosure generally relates to electrochromic devices comprising, in the following order a substantially transparent substrate (402); an optional diffusion barrier layer (412); a stack of interleaved index matching layers including a first index matching layer and a second index matching layer, the first index matching layer being preferably made of TiOx or Nb20s 41Q and having a higher refractive index than the second index matching layer preferably made of silicon oxide; a first conductive layer (420); a solid state and inorganic electrochromic stack (430); and a second conductive layer (440).

### CROSS-REFERENCE TO RELATED APPLICATION

This application claims benefit of U.S. Provisional Patent Application 62/644,261, titled “ELECTROCHROMIC DEVICE COLOR REFLECTANCE AND TRANSMISSION” and filed on Mar. 16, 2018, which is hereby incorporated by reference in its entirety and for all purposes.

### FIELD

The disclosure generally relates to electrochromic devices and in particular to color tuning with material layers in electrochromic devices.

### BACKGROUND

Electrochromism is a phenomenon in which a material exhibits a reversible electrochemically-mediated change in an optical property when placed in a different electronic state, typically by being subjected to a voltage change. The optical property is typically one or more of color, transmittance, absorbance, and reflectance.

Electrochromic materials may be incorporated into, for example, windows and mirrors. The optical properties of such windows and mirrors are affected by changes in composition of the layers of electrochromic devices and other materials in the optical path.

### SUMMARY

Certain aspects pertain to electrochromic devices comprising a stack of interleaved reflective index matching layers including a first index matching layer and a second index matching layer. The first index matching layer has a higher refractive index than the second index matching layer.

Certain aspects pertain to an electrochromic device comprising, in the following order, a substantially transparent substrate, a stack of interleaved index matching layers, a first conductive layer (e.g., a transparent conductive oxide layer), a solid state and inorganic electrochromic stack, and a second conductive layer (e.g., a transparent conductive oxide layer). The stack of interleaved index matching layers includes a first index matching layer and a second index matching layer. The first index matching layer has a higher refractive index than the second index matching layer. In some cases, the first index matching layer is a TiOₓ material layer or an Nb₂O₅ material layer. In some cases, the electrochromic device further comprises a diffusions barrier layer. In some cases, the first index matching layer is a transparent material having a refractive index in the range of about 2.2 to about 2.7.

Certain aspects pertain to an electrochromic device comprising, in the following order, a substantially transparent substrate (e.g., soda lime glass), a diffusion barrier layer, a TiOₓ material layer or a Nb₂O₅ material layer, a first conductive layer (e.g., a transparent conductive oxide layer), a solid state and inorganic electrochromic stack, and a second conductive layer (e.g., a transparent conductive oxide layer). In some cases, the electrochromic device further comprises one or more defect mitigating insulating layers.

These and other features and embodiments will be described in more detail below with reference to the drawings.

### BRIEF DESCRIPTION OF THE DRAWINGS

FIG. 1 depicts a schematic illustration of a cross section of an electrochromic device, according to aspects.

FIGS. 2A and 2B depict schematic illustrations of a cross section of an electrochromic device, according to certain aspects.

FIG. 3 depicts a schematic illustration of a cross section of coatings on a substrate including an electrochromic device stack, first and second conductive layers sandwiching the electrochromic device stack, and intervening layers between the substrate and the first conductive layer, according to embodiments.

FIG. 4 depicts a schematic illustration of a cross section of an electrochromic device having one or more intervening layers between the substrate and the first conductive layer, according to embodiments.

FIG. 5 is a micrograph of a cross-section of an electrochromic device, according to an implementation.

FIG. 6 depicts a schematic illustration of a cross section of an electrochromic device having one or more intervening layers with a diffusion barrier and index matching (IM) layers that include either a TiOₓ layer or an Nb₂O₅ layer, according to embodiments.

FIG. 7A depicts a graph of modeled reflectance versus wavelength incident an electrochromic device, according to an implementation.

FIG. 7B depicts a graph of modeled transmittance versus wavelength incident the electrochromic device of FIG. 7A.

FIG. 8A depicts a graph of modeled reflectance versus wavelength incident an electrochromic device, according to an implementation.

FIG. 8B depicts a graph of modeled transmittance versus wavelength incident the electrochromic device of FIG. 8A.

FIG. 9A depicts a graph of modeled reflectance versus wavelength incident an electrochromic device, according to an implementation.

FIG. 9B depicts a graph of modeled transmittance versus wavelength incident the electrochromic device of FIG. 9A.

FIG. 10A depicts a graph of modeled reflectance versus wavelength incident an electrochromic device, according to an implementation.

FIG. 10B depicts a graph of modeled transmittance versus wavelength incident the electrochromic device of FIG. 10A.

FIG. 11A depicts a graph of modeled reflectance versus wavelength incident an electrochromic device, according to an implementation.

FIG. 11B depicts a graph of modeled transmittance versus wavelength incident the electrochromic device of FIG. 11A.

FIG. 12A depicts a graph of modeled reflectance versus wavelength incident an electrochromic device, according to an implementation.

FIG. 12B depicts a graph of modeled transmittance versus wavelength incident the electrochromic device of FIG. 12A.

FIG. 13A depicts a graph of modeled reflectance versus wavelength incident an electrochromic device, according to an implementation.

FIG. 13B depicts a graph of modeled transmittance versus wavelength incident the electrochromic device of FIG. 13A.

FIG. 14A depicts a graph of modeled reflectance versus wavelength incident an electrochromic device, according to an implementation.

FIG. 14B depicts a graph of modeled transmittance versus wavelength incident the electrochromic device of FIG. 14A.

### DETAILED DESCRIPTION

Certain aspects pertain to electrochromic devices with material layers configured not only for tuning color reflectance/transmittance and other optical properties, but also for improved process control. These electrochromic devices include a first conductive layer, a second conductive layer, and an electrochromic stack between the first and second conductive layers. In some cases, the electrochromic devices include intervening material layers between the substrate and the first conductive layer. These intervening material layers may have a diffusion barrier and/or index matching material lavers for controlling reflection and transmission of wavelengths of light (color). The thickness and materials of these intervening material layers may also be configured to reduce haze and improve process control. These and other aspects are described below with reference to the accompanying drawings. The features illustrated in the drawings may not be to scale. For example, the thicknesses of material layers in certain drawings may not be to scale.

I. Electrochromic Device Structure

Before turning to a more detailed description on designs of intervening material layers between the substantially transparent substrate and the first transparent conductive layer, examples of the structure of an electrochromic device are provided. An electrochromic device generally includes two conductive layers (sometimes referred to herein as “conductors”) that sandwich an electrochromic stack. The electrochromic stack typically includes an electrochromic (EC) layer, a counter electrode (CE) layer, and optionally one or more ion conducting (IC) layers that allow ion transport but are electrically insulating. The more ion conducting and electrically insulating the IC layer is, the more efficient the device will be at coloring and retaining its color, respectively.

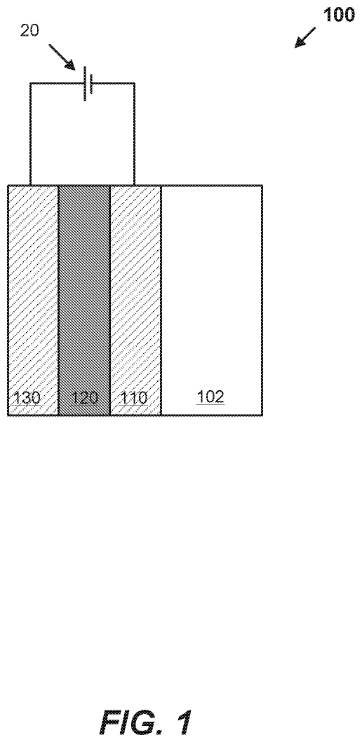

FIG. 1 is a schematic illustration of a cross-section of an electrochromic device 100, according to embodiments. The electrochromic device 100 includes a substrate 102 (e.g., glass), a first conductor 110, an electrochromic stack 120, and a second conductor 130. A voltage source, 20, operable to apply an electric potential across electrochromic stack 120 effects the transition of the electrochromic device 100 between tint states such as, for example, between a bleached state and a colored state.

In certain implementations, the electrochromic device 100 also includes a diffusion barrier of one or more layers between the substrate 102 and the first conductor 110. In some cases, the substrate 102 may be fabricated with the diffusion barrier.

In certain embodiments, the electrochromic stack is a three-layer stack including an EC layer, optional IC layer that allows ion transport but is electrically insulating, and a CE layer. The EC and CE layers sandwich the IC layer. Oftentimes, but not necessarily, the EC layer is tungsten oxide based and the CE layer is nickel oxide based, e.g., being cathodically and anodically coloring, respectively. In one embodiment, the electrochromic stack is between about 100 nm and about 500 nm thick. In another embodiment, the electrochromic stack is between about 410 nm and about 600 nm thick. For example, the EC stack may include an electrochromic layer that is between about 200 nm and about 250 nm thick, an IC layer that is between about 10 and about 50 nm thick, and a CE layer that is between about 200 nm and about 300 nm thick.

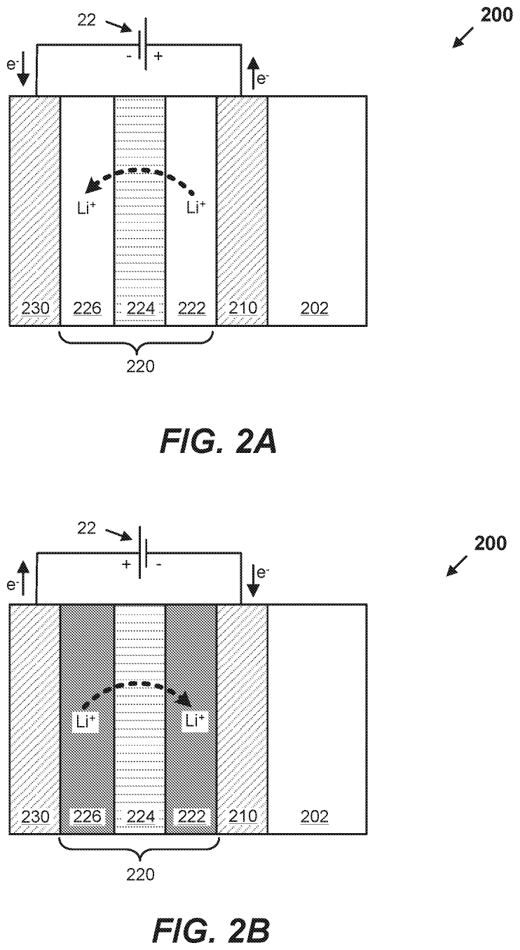

FIGS. 2A and 2B are schematic cross-sections of an electrochromic device 200, according to embodiments. The electrochromic device 200 includes a substrate 202, a first conductor 210, an electrochromic stack 220, and a second conductor 230. The electrochromic stack 220 includes an electrochromic layer (EC) 222, an optional ion conducting (electronically resistive) layer (IC) 224, and a counter electrode layer (CE) 226. A voltage source 22 is operable to apply a voltage potential across the electrochromic stack 220 to effect transition of the electrochromic device between tint states such as, for example, between a bleached state (refer to FIG. 2A) and a colored state (refer to FIG. 2B). In certain implementations, the electrochromic device 200 also includes a diffusion barrier located between the substrate 202 and the first conductor 210.

In certain implementations of the electrochromic device 200 of FIGS. 2A and 2B, the order of layers in the electrochromic stack 220 may be reversed with respect to the substrate 202 and/or the position of the first and second conductors may be switched. For example, in one implementation the layers may be in the following order: substrate 202, second conductor 230, CE layer 226, optional IC layer 224, EC layer 222, and first conductor 210.

In certain implementations, the CE layer may include a material that is electrochromic or not. If both the EC layer and the CE layer employ electrochromic materials, one of them is a cathodically coloring material and the other an anodically coloring material. This construct allows for complimentary coloring (and bleaching) function. For example, the EC layer may employ a cathodically coloring material and the CE layer may employ an anodically coloring material. This is the case when the EC layer is a tungsten oxide and the counter electrode layer is a nickel tungsten oxide. The nickel tungsten oxide may be doped with another metal such as tin, niobium or tantalum.

During an exemplary operation of an electrochromic device (e.g. electrochromic device 100 or electrochromic device 200), the electrochromic device can reversibly cycle between a bleached state and a colored state. For simplicity, this operation is described in terms of the electrochromic device 200 shown in FIGS. 2A and 2B, but applies to other electrochromic devices described herein as well. As depicted in FIG. 2A, in the bleached state, a voltage is applied by the voltage source 22 at the first conductor 210 and second conductor 230 to apply a voltage potential across the electrochromic stack 220, which causes available ions (e.g. lithium ions) in the stack to reside primarily in the CE layer 226. If the EC layer 222 contains a cathodically coloring material, the device is in a bleached state. In certain electrochromic devices, when loaded with the available ions, the CE layer can be thought of as an ion storage layer. Referring to FIG. 2B, when the voltage potential across the electrochromic stack 220 is reversed, the ions are transported across optional IC layer 224 to the EC layer 222, which causes the material to transition to the colored state. Again, this assumes that the optically reversible material in the electrochromic device is a cathodically coloring electrochromic material. In certain embodiments, the depletion of ions from the counter electrode material causes it to color also as depicted. In other words, the counter electrode material is anodically coloring electrochromic material. Thus, the EC layer 222 and the CE layer 226 combine to synergistically reduce the amount of light transmitted through the stack. When a reverse voltage is applied to the electrochromic device 200, ions travel from the EC layer 222, through the IC layer 224, and back into the CE layer 226. As a result, the electrochromic device 200 bleaches i.e. transitions to the bleached states. In certain implementations, electrochromic devices can operate to transition not only between bleached and colored states, but also to one or more intermediate tint states between the bleached and colored states. Although FIGS. 2A and 2B show Li+ (lithium ions) as travelling between the EC layer 222 and the CE layer 226 through the IC layer 224, other ions could be implemented such as H+ Na+, K+, and the like.

Some pertinent examples of electrochromic devices are presented in the following U.S. Patent Applications, each of which is hereby incorporated by reference in its entirety: U.S. patent application Ser. No. 12/645,111, titled “FABRICATION OF LOW DEFECTIVITY ELECTROCHROMIC DEVICES” and filed on Dec. 22, 2009; U.S. patent application Ser. No. 12/772,055, titled “ELECTROCHROMIC DEVICES” and filed on Apr. 30, 2010; U.S. patent application Ser. No. 12/645,159, titled “ELECTROCHROMIC DEVICES” and filed on Dec. 22, 2009; U.S. patent application Ser. No. 12/814,279, titled “ELECTROCHROMIC DEVICES” and filed on Jun. 11, 2010; and U.S. patent application Ser. No. 13/462,725, titled “ELECTROCHROMIC DEVICES” and filed on May 2, 2012.

In certain implementations, the electrochromic device, e.g., of an electrochromic window, includes a first conductive layer, a second conductive layer, an electrochromic stack sandwiched between the first and second conductive layers, and one or more intervening layers between the substrate (e.g., soda lime glass, tempered or not) and the first conductive layer. In some cases, these intervening layers include a diffusion barrier (e.g., sodium diffusion barrier) and refractive index matching layers (sometimes referred to herein as “IM layers” or “color tuning layers”) for controlling reflected and transmitted wavelengths (color). In some cases, one or more of the color tuning layers may also serve as an ion diffusion barrier, e.g., to prevent leaching of sodium ions from the substrate into the device which can poison it, and, to prevent ions (e.g., lithium ions) from leaching out of the electrochromic device and thus deteriorate its function.

In certain implementations, an electrochromic device includes intervening layers between the substrate and the first conductive layer (e.g., F:SnOₓ) that include a diffusion barrier layer and a stack of interleaved IM layers. In many cases, the stack of interleaved IM layers is a bi-layer stack of a first index matching layer and a second index matching layer where the second index matching layer has a higher refractive index value than the first index matching layer. In certain implementations, the second higher refractive index matching layer has a thickness in the range of about 10 nm to about 30 nm and the first lower refractive index matching layer has a thickness in the range of about 20 nm to about 40 nm. In some cases, the diffusion barrier layer is located directly on the substrate and the bi-layer stack of interleaved IM layers (e.g., SnOₓ/SiOₓ) is located on the diffusion barrier layer. In other cases, the diffusion barrier layer is located on the bi-layer stack of interleaved IM layers. The stack of interleaved IM layers, bi-layer, tri-layer, etc., can reduce reflection of wavelengths (e.g., visible wavelengths) at the interface of the first conductive layer and the substrate.

In one implementation, one or more of the index matching layers has a thickness in a range of about 5 nm to about 8 nm. In another implementation, one or more of the index matching layers has a thickness in a range of about 20 nm to about 30 nm. For example, the second higher refractive index matching layer may have a thickness in a range of about 20 nm to about 30 nm.

For example, in one implementation where a first F:SnOₓ (FTO) conductive layer is deposited directly on a glass substrate, the reflectance component of the light at the interface of the first FTO conductive layer and the glass substrate is R˜2%. Including a stack of SnOx/SiOx IM layers into the intervening layers reduces this reflectance through destructive interference between the reflection from each of the interfaces along with a phase shift of the reflected wavefronts due to the refractive index of the materials and the thicknesses of the material layers. In certain implementations, both selection and placement of materials of the IM layers provides an index difference along with the correct thickness to reduce the reflectance across the visible wavelengths. The reduction of the reflectance from this interface results in a smoother transmission spectrum with less interference fringes that would normally result from interference between the top and bottom interfaces of the FTO conductive layer.

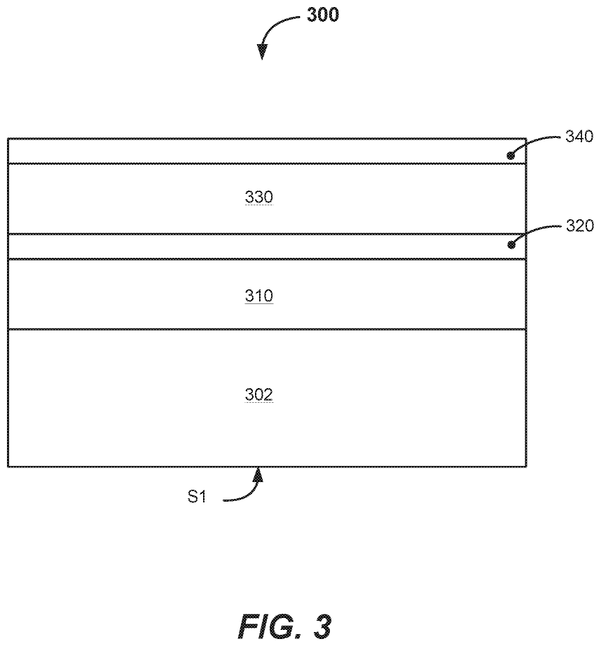

FIG. 3 depicts a schematic illustration of a cross section of an electrochromic device 300 having one or more intervening layers 310 between the substrate 302 (e.g., substantially transparent substrate such as soda lime glass) and the first conductive layer 320, according to embodiments. As shown, the electrochromic device 300 includes, in order, a substrate 302, the one or more intervening layers 310, the first conductive layer 320, an electrochromic stack 330, and a second conductive layer 340. The electrochromic stack 310 includes an electrochromic (EC) layer, a counter electrode (CE) layer, and an ion conducting (electronically resistive) (IC) layer (or interfacial region serving as an IC layer) between the EC layer and the CE layer. The substrate has an outer surface “S1.”

As shown, the first and second conductive layers 320, 340 (sometimes referred to herein as “first and second conductors” or collectively as “conductors”) sandwiching the electrochromic stack 310. In certain implementations, one or both of the first and second conductive layers 320, 340 is a transparent conductive oxide (TCO). Generally, but not necessarily, the TCO materials are high band gap metal oxides. Some examples of TCO materials that can be used include, e.g., fluorinated tin oxide (FTO), indium tin oxide (ITO), aluminum zinc oxide (AZO) and other metal oxides, doped with one or more dopants or not, for example. In some cases, the TCO layer is between about 200 nm and 500 nm thick. In some cases, the TCO layer is between about 100 nm and about 500 nm thick. In some cases, the TCO layer is between about 10 nm and about 100 nm thick. In some cases, the TCO layer is between about 10 nm and about 50 nm thick. In some cases, the TCO layer is between about 200 nm and about 500 nm thick. In some cases, the TCO layer is between about 100 nm and about 250 nm thick.

In some cases, the electrochromic device 300 includes a diffusion barrier in the intervening layers 310 between the substrate 302 (e.g., substantially transparent substrate such as soda lime glass) and the first conductive layer 320. The diffusion barrier may include one or more layers of material. The diffusion barrier is implemented to prevent sodium ions from diffusing into the electrochromic stack layers and may also, optionally, be optically tuned to enhance various optical properties of the entire construct, e.g., % optical transmission (% T), haze, color, reflection and the like. Some examples of materials that can be used in a diffusion barrier layer include one more of, for example, SiOₓ (e.g., SiO₂ silicon dioxide or SiO), SnO (e.g., SnO₂, tin dioxide, or SnO, tin oxide), F:SnOₓ (also referred to herein as “FTO”), and the like. In one aspect, material layers that function as a diffusion barrier include a tri-layer stack of SiO₂, SnO₂, and SiOₓ, wherein the SiO₂ layer has a thickness in the range of between about 20 nm and about 30 nm, the SnO₂ layer has a thickness in the range of between about 20 mm and about 30 nm, and the SiOₓ layer has a thickness in the range of about 2 nm to about 10 nm. In one aspect, the SiOₓ layer of the tri-layer diffusion barrier is a monoxide or a mix of the monoxide with SiO₂. In one aspect, the tri-layer diffusion barrier may be sandwiched between an FTO and the substrate. In certain aspects, the diffusion barrier is in a bi-layer or tri-layer construction of SnO₂, SiO₂ and SiOₓ in various combinations. In one embodiment, thicknesses of individual diffusion barrier layers may be in the range between about 10 nm and about 30 nm. In certain cases, thicknesses of individual diffusion barrier layers may be in the range of about 20 nm to about 30 nm. In one implementation, one of the intervening layers 310 primarily functions as a diffusion barrier. Typically this diffusion barrier layer is located directly on the substrate. In other implementations, a diffusion barrier may not be necessary, for example, if the substrate is a sodium-free substrate such as plastic or an alkali-free glass. In these cases, the electrochromic device may not include a material layer for the sole function of being a diffusion barrier.

In certain aspects, additional material layers of material may be included in the electrochromic device 300 such as one or more of defect mitigating insulating layers (DMILs), anti-reflection layers, electromagnetic shielding layers, and other functional layers. Alternatively or additionally, one or more of the layers of materials can serve multiple functions. For example, one layer on the substrate can function both as a diffusion barrier and as one of the IM layers. As another example, one layer can function both as a DMIL and as one of the IM layers. Some examples of layers of materials that may be included are described in detail in PCT application PCT/US17/47664, titled “ELECTROMAGNETIC-SHIELDING ELECTROCHROMIC WINDOWS,” filed on Aug. 18, 2017, which is hereby incorporated by reference in its entirety. Detailed examples of DMILs that can be included are described in detail in U.S. patent application Ser. No. 15/086,438, titled “DEFECT-MITIGATION LAYERS IN ELECTROMAGNETIC DEVICES” and filed on Mar. 31, 2016, which is hereby incorporated by reference in its entirety.

In certain implementations, the electrochromic device 300 includes one or more DMILs such as those described in U.S. patent application Ser. No. 13/763,505, titled “DEFECT MITIGATION LAYERS IN ELECTROCHROMIC DEVICES” and filed on Feb. 8, 2013, which is hereby incorporated by reference in its entirety. A DMIL prevents electronically conductive layers and/or electrochromically active layers from contacting layers of the opposite polarity and creating a short circuit in regions where certain types of defects form. A DMIL layer may have some level of electrical conductivity, but is it generally higher in resistance than a conductor layer material such as ITO, FTO, AZO, and the like. In some embodiments, a DMIL can encapsulate particles and prevent them from ejecting from the electrochromic stack and possibly cause a short circuit when subsequent layers are deposited. In certain embodiments, a DMIL has an electronic resistivity of between about 1 and 5×10¹⁰ Ohm-cm. In one aspect, a DMIL includes one or more of the following metal oxides: cerium oxide, titanium oxide, aluminum oxide, zinc oxide, tin oxide, silicon aluminum oxide, tungsten oxide, nickel tungsten oxide, tantalum oxide, and oxidized indium tin oxide. In certain embodiments, a DMIL contains a nitride, carbide, oxynitride, or oxycarbide such as nitride, carbide, oxynitride, or oxycarbide analogs of the listed oxides, e.g., silicon aluminum oxynitride. For example, the DMIL may include one or more of the following metal nitrides: titanium nitride, aluminum nitride, silicon nitride, and tungsten nitride. The DMIL may also contain a mixture or other combination of oxide and nitride materials (e.g., a silicon oxynitride). In some cases, the material chosen for the DMIL is a material that integrates well (i.e. compatible) with the electrochromic stack or with materials between the substrate and the first conductive layers. The integration may be promoted by (a) employing compositions similar to those of materials in layers adjacent to DMIL in the stack (promotes ease of fabrication), and (b) employing materials that are optically compatible with the other materials in the stack and reduce quality degradation in the overall stack.

Electrochromic devices described herein such as those described with reference to FIGS. 1, 2A, 2B, 3, 4, 5, and 6 can be incorporated, for example, in electrochromic windows. In these examples, the substrate is a transparent or substantially transparent substrate such as glass. For example, the substrate 102 or the substrate 202 may be architectural glass upon which electrochromic device layers are fabricated. Architectural glass is glass that can be used as a building material. Architectural glass is typically used in commercial buildings, but may also be used in residential buildings, and typically, though not necessarily, separates an indoor environment from an outdoor environment. In certain embodiments, architectural glass is at least 20 inches by 20 inches. In some embodiments, architectural glass can be as large as about 72 inches by 120 inches.

In some cases, the glass is pre-fabricated with the first conductor layer and the intervening layers on the substrate. In these cases, the electrochromic stack and the second conductive layer are deposited on the glass with the pre-fabricated layers.

As larger and larger substrates are used in electrochromic window applications, it becomes increasingly more desirable to reduce the number and extent of defects in the electrochromic devices, otherwise performance and visual quality of the electrochromic windows may suffer. Certain embodiments described herein may reduce defectivity in electrochromic windows.

In some embodiments, one or more electrochromic devices are integrated into an insulating glass unit (IGU). An insulated glass unit includes multiple panes (also referred to as “lites”) with a spacer sealed between panes to form a sealed interior region that is thermally insulating and can contain a gas such as an inert gas. In some embodiments, an IGU includes multiple electrochromic lites, each lite having at least one electrochromic device.

In certain embodiments, an electrochromic device is fabricated by thin film deposition methods such as, e.g., sputter deposition, chemical vapor deposition, pyrolytic spray on technology and the like, including combinations of thin film deposition technologies known to one of ordinary skill in the art. In one embodiment, the electrochromic device is fabricated using all plasma vapor deposition.

In certain embodiments, an electrochromic device may further include one or more bus bars for applying voltage to the conductors of the electrochromic device. The bus bars are in electrical communication with a voltage source. The bus bars are typically located at one or more edges of the electrochromic device and not in the center region, for example, the viewable central area of an IGU. In some cases, the bus bars are soldered or otherwise connected to the first and second conductors to apply a voltage potential across the electrochromic stack. For example, ultrasonic soldering, which makes a low resistance connection, may be used. Bus bars may be, for example, silver ink based materials and/or include other metal or conductive materials such as graphite and the like.

II. Material layers tuned to enhance optical properties and improve process control in electrochromic windows

According to certain aspects, the thicknesses and types of materials used in material layers of the electrochromic device are designed to enhance optical properties of the entire electrochromic window construct such as reflectance (e.g., color-tuned reflectance), transmission (e.g., color-tuned transmission), haze, and the like. In addition, the thicknesses and materials can be configured for improved process control. In some aspects, the intervening material layers between the substrate and the first conductive layer of the electrochromic devices are designed for one or more of reflectance and/or transmittance of desired wavelengths, reducing haze, and improving thickness control. In some cases, these intervening material layers include a diffusion barrier (e.g., sodium diffusion barrier) and refractive index matching layers (sometimes referred to as “TM layers” or “color tuning layers”) for controlling the color of reflected and transmitted light. In other cases, the IM layers are omitted or the diffusion barrier is omitted.

A. Color Tuned Reflectance and/or Transmission using IM Layers

In certain implementations, the intervening material layers between the first conductive layer and the substrate of an electrochromic device include a diffusion barrier and a stack of two or more index matching (IM) layers. In some cases, one or more of the IM layers may also function as a diffusion barrier. The stack of IM layers includes adjacent interfacing layers having different refractive index values. The refractive index changes at the interfaces and the thicknesses of the layers determine the reflection and absorption of light waves according to wavelength. The thickness and order of the IM layers along with the types of materials based on refractive index values can be selected to suppress or enhance the transmittance and reflectance of particular wavelengths of light incident the electrochromic window. For example, the thickness, materials, and order of the IM layer(s) can be selected and configured to reduce transmission and enhance reflection of certain wavelengths of light (e.g., yellow light having wavelengths in the range of about 550-580 nm) through an electrochromic window or otherwise shift the transmission of wavelengths of light through an electrochromic window toward desirable wavelengths (e.g., between 490-530 nm for green light or between 460-480 nm for blue light).

The table below shows examples of values of refractive index and absorption properties of 550 nm wavelength (yellow light) for different materials, according to one implementation. The absorptive property for each of these materials for 555 nm wavelength is negligible, shown in the table as zero (0).

| | Refractive Index for | Absorption for |
|---|---|---|
| Materials | 550 nm wavelength | 550 nm wavelength |
| SiOₓ | 1.46 | 0 |
| SnOₓ | 1.94 | 0 |
| F:SnOₓ | 1.96 | 0 |
| TiOₓ | 2.2-2.7 | 0 |
| Nb₂O₅ | 2.38 | 0 |

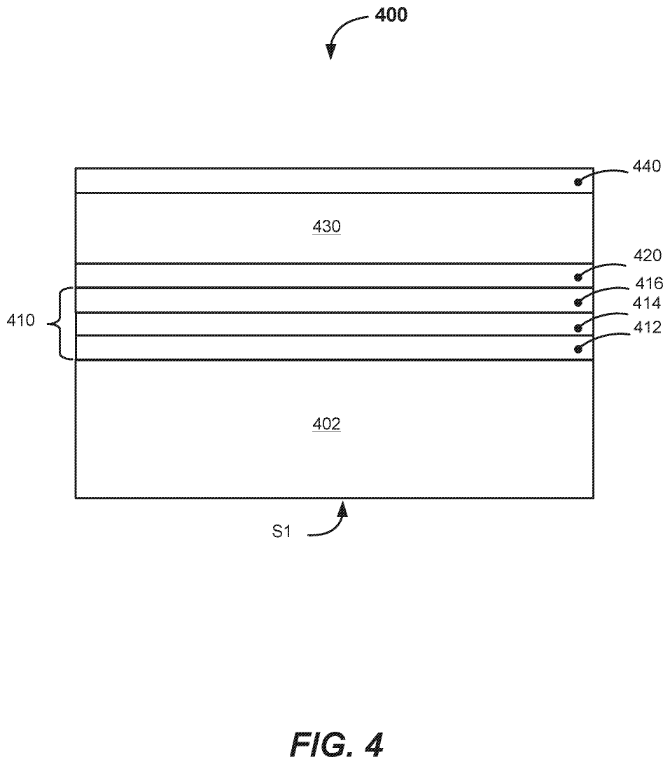

FIG. 4 depicts a schematic illustration of a cross section of an electrochromic device 400 having one or more intervening layers 410 between a substrate 402 (e.g., a substantially transparent substrate such as soda lime glass) and a first conductive layer 420, according to embodiments. As shown, the electrochromic device 400 includes, in order, the substrate 402, the one or more intervening layers 410, the first conductive layer 420, an electrochromic stack 430, and a second conductive layer 440. One or both of the first and second conductive layers 420, 440 may be transparent conductive oxide (TCO). Some examples of TCO materials that can be used include, e.g., fluorinated tin oxide (FTO), indium tin oxide (ITO), aluminum zinc oxide (AZO) and other metal oxides, doped with one or more dopants or not, for example. The electrochromic stack 410 includes an electrochromic (EC) layer, a counter electrode (CE) layer, and optionally a distinct ion conducting (electronically resistive) (IC) layer between the EC layer and the CE layer. The intervening layers 410 include a first intervening layer 412, a second intervening layer 414, and a third intervening layer 416. In one case, the third intervening layer 416 is omitted. In certain implementations, the intervening layers 410 include a diffusion barrier and index matching (IM) layers with adjacent IM layers having different refractive indexes. In one implementation, the third intervening layer 416 acts as both a diffusion barrier and as an index matching layer, and the first intervening layer 412 and the second intervening layer 414 are also index matching layers. In another implementation, the first intervening layer 412 is a diffusion barrier and the second intervening layer 414 and the third intervening layer 416 are index matching layers. In another implementation, the first intervening layer 412 acts as both a diffusion barrier and as an index matching layer, and the first intervening layer 412 and the second intervening layer 414 are also index matching layers. The substrate has an outer surface “51.”

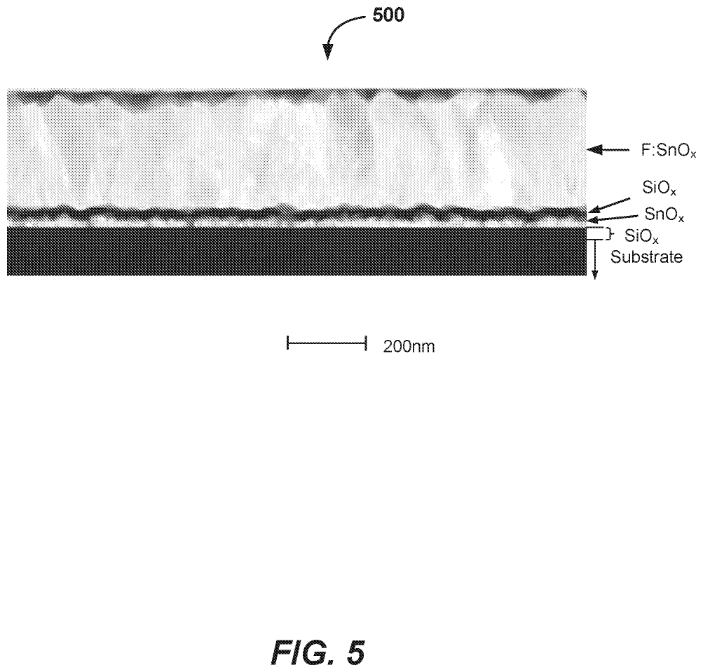

FIG. 5 is a micrograph of a cross-section of a portion of an electrochromic device 500 of an electrochromic window. The electrochromic device 500 has a similar order of material layers as the electrochromic device 400 shown in FIG. 4. The electrochromic device 500 includes intervening layers between a substrate of soda lime glass and a first transparent conductive layer of F: SnOx. The intervening material layers include a first SiO, layer, a SnOₓ layer, and a second SiO, layer. In certain implementations, the thickness of each of the first and second SiO, layers is in the range of about 10 nm to 30 nm, the thickness of the SnOₓ layer is in the range of about 40 to 50 nm, and the thickness of the first transparent conductive layer of F:SnOₓ is about 340 nm. In one case, the first SnOₓ layer is 15-30 nm. Optionally, an electrochromic stack and a second transparent conductive layer are deposited over the first transparent conductive layer to complete the fabrication of the electrochromic device 500 of the electrochromic window. In this example, the reflected color from the surface of the electrochromic window is largely controlled by the relatively high refractive index of the SnOₓ layer as compared to the lower value of the refractive index of adjacent first and second SiOₓ layers. In the deposition of the illustrated electrochromic device 400, the difficulty of thickness control of the SnOₓ layer resulted in varying thickness across the layer. The SnOₓ material can nucleate and grow in a discontinuous and/or bumpy crystalline fashion leading to additional challenges with haze and process control.

As shown in FIG. 5, the bottom SnOₓ layer varies in thickness due to the rocky crystalline nature of the deposited film. Silicon oxide layers are generally conformal in nature, that they conform to the contours of the surface to which they are applied. In this example, the deposited first SiOₓ layer, adjacent the substrate is smooth because the substrate (glass) is smooth. The second SiOₓ layer, atop the bottom SnOₓ layer, conforms to the contours of the bottom SnOₓ layer and acts to fill in the valleys and cover the peaks to generally make the topography smoother, due to its relative thickness compared to the tin oxide layer. Still, since it is conformal, its top surface is not planar, e.g. as compared to the first SiOₓ layer adjacent the glass substrate. Thus the F:SnOₓ layer deposited on top of the second SiOₓ layer is not as planar as it could be either; its topography is influenced by the underlying layer's topography. One aspect of the invention is applying intervening layers that are all conformal in nature. That way, the uneven topography of intervening layers and the associated uneven nature of layers deposited on top of them can be avoided. This helps reduce haze, specular reflection and other negative aspects of optical coatings described herein.

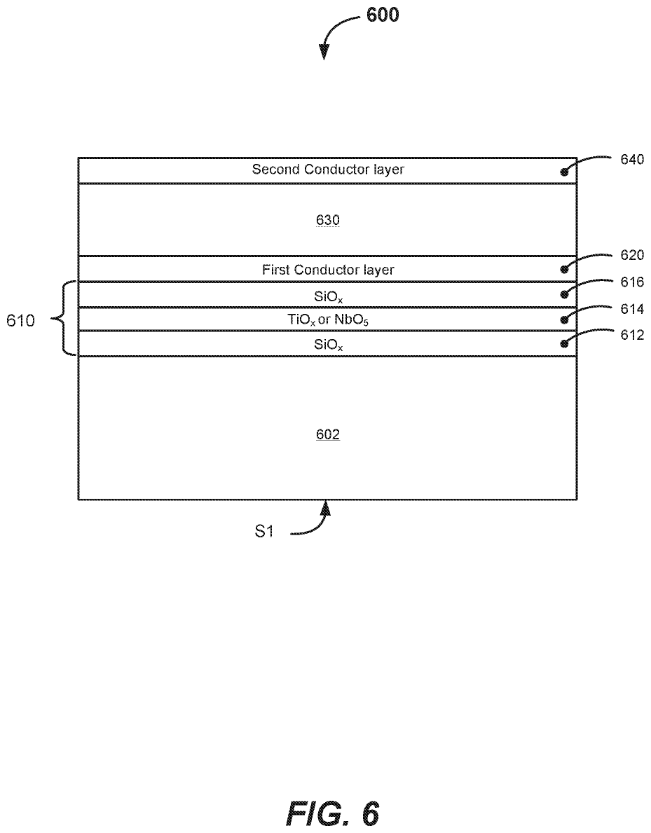

Depositing a conformal layer provides more consistent properties for depositing one or more additional layers above it. In certain embodiments such as the illustrated example shown in FIG. 6, an alternative material to SnOₓ may be used. In certain examples, conformal tin oxide may be substituted for non-conformal tin oxide, e.g. where the stack is not going to be later subjected to conditions that would recrystallize the tin oxide. In other examples, materials can be used that can be deposited with a more uniform thickness can be used, e.g. in a conformal manner, where they will remain conformal despite subsequent higher process temperatures that would otherwise crystallize, recrystallize or otherwise change the topography of the materials. Some examples of materials that can be used include metal nitrides and metal oxides. Examples would include nitrides, oxides and silicides of tungsten, titanium and niobium, including mixed metal nitrides, oxides and silicides. Some examples include titanium nitride, tungsten nitride, niobium nitride, titanium oxide, niobium oxide, titanium silicide, tungsten silicide, titanium aluminum nitride, titanium silicon nitride and tungsten silicon nitride. In one embodiment, TiOₓ and Nb₂O₅ are used in tandem as a bilayer, with the TiOₓ layer closer to the substrate. In one embodiment, TiOₓ and Nb₂O₅ are used in tandem as a bilayer, with the Nb₂O₅ closer to the substrate. In one embodiment, TiOₓ or Nb₂O₅ is used as an intervening layer.

According to one aspect, an electrochromic device includes intervening material layers with a diffusion barrier and IM layers that include either a TiOₓ layer or an Nb₂O₅ layer or any other material that has a comparable refractive index (e.g., in a range of about 2.2 and 2.7) and is transparent at wavelengths greater than 350 nm. In one example, the electrochromic device includes on a substrate, in the following order: a) a stack of three intervening material layers including a first SiOₓ layer, a TiOₓ layer, and a second SiOₓ layer b) a first conductive layer (e.g., F:SnOₓ), c) an electrochromic stack, and) a second conductive layer (e.g., F:SnOₓ). In another example, the electrochromic device includes on a substrate, in the following order: a) a stack of three intervening material layers including a first SiOₓ layer, a Nb₂O₅ layer, and a second SiOₓ layer, b) a first conductive layer (e.g., F:SnOₓ), c) an electrochromic stack, and) a second conductive layer (e.g., F:SnOₓ). A TiOₓ or Nb₂O₅ layer provides improved thickness control and improved haze properties. In some cases, additional layers may be included on top of the second conductive layer. In addition, since a TiOₓ layer or a Nb₂O₅ layer is an effective diffusion barrier, the inclusion of such an intervening layer may allow for the omission of the second SiOₓ layer, which reduces manufacturing complexity. In one example, the electrochromic device includes on a substrate, in the following order: a) a stack of interleaved layers of TiOₓ and SiOₓ, b) a first conductive layer (e.g., F:SnOₓ), c) an electrochromic stack, and d) a second conductive layer (e.g., F:SnOₓ). In another example, the electrochromic device includes on a substrate, in the following order: a) a stack of interleaved layers of Nb₂O₅ layer and SiOₓ, b) a first conductive layer (e.g., F:SnOₓ), c) an electrochromic stack, and d) a second conductive layer (e.g., F:SnOₓ). One or both of the first and second conductive layers may be a transparent conductive oxide (TCO). Some examples of TCO materials that can be used include, e.g., fluorinated tin oxide (FTO), indium tin oxide (ITO), aluminum zinc oxide (AZO) and other metal oxides, doped with one or more dopants or not, for example.

FIG. 6 depicts a schematic illustration of a cross section of an electrochromic device 600 having one or more intervening layers 610 between a substrate 602 (e.g., substantially transparent substrate such as soda lime glass) and a first conductive layer 620, and with a diffusion barrier and IM layers that include either a TiOₓ layer or an Nb₂O₅ layer, according to embodiments. As shown, the electrochromic device 600 includes, in order, the substrate 602, the intervening layers 610, the first conductive layer 620, an electrochromic stack 630, and a second conductive layer 640. The electrochromic stack 610 includes an electrochromic (EC) layer, a counter electrode (CE) layer, and optionally a distinct ion conducting (electronically resistive) (IC) layer between the EC layer and the CE layer. The intervening layers 610 include a first SiOₓ layer 612, a TiOₓ layer or an Nb₂O₅ layer 614, and a second SiOₓ layer 616. In another embodiment, the second SiOₓ layer 616 is omitted. The TiOₓ layer or the Nb₂O₅ layer 614 acts as both a diffusion barrier and as an index matching layer. One or both of the first and second conductive layers 620, 640 may be transparent conductive oxide (TCO). Some examples of TCO materials that can be used include, e.g., fluorinated tin oxide (FTO), indium tin oxide (ITO), aluminum zinc oxide (AZO) and other metal oxides, doped with one or more dopants or not, for example. The substrate has an outer surface “51.” A portion of the substrate is illustrated. As indicated, the thickness of the substrate is greater than the portion shown in the drawing.

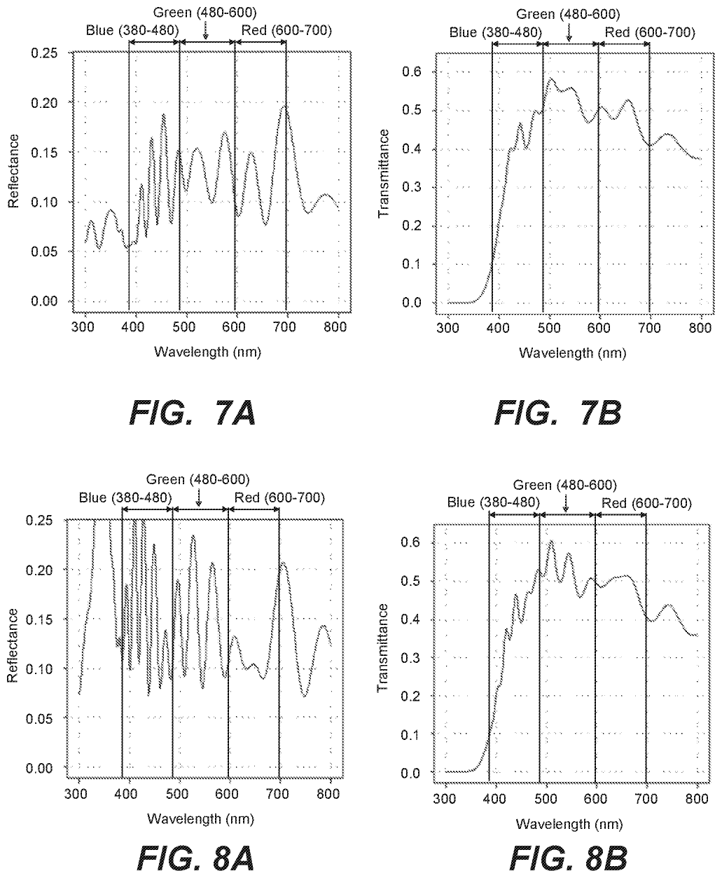

In one implementation, the intervening layers of the electrochromic device 600 in FIG. 6 includes a TiOₓ layer 614 having a thickness of in a range of about 5 nm to about 7 nm (e.g., 6 nm) and a SiO, layer 616 having a thickness in a range of about 20 nm to about 30 nm. In another implementation, the intervening layers of the electrochromic device 600 in FIG. 6 includes a Nb₂O₅ layer 614 having a thickness of 7 nm and a SiOₓ layer 616 having a thickness of in a range of about 20 nm to about 30 nm. FIGS. 7A-14B are graphs of plots of modeled reflectance and transmittance values versus wavelength incident certain electrochromic devices, according to implementations. In each graph, the color bands from CIE Tristimulus curves are shown overlaying the plots for reference.

FIG. 7A and FIG. 7B depict graphs of modeled reflectance and transmittance values versus wavelength incident an electrochromic device having material layers on the substrate, in the following order: a) a first SiOₓ layer having a thickness of 30 nm, b) a SnOₓ layer having a thickness of 20 nm, c) a second SiOₓ layer having a thickness of 30 nm, d) a first conductive F: SnOₓ layer, e) an electrochromic stack, and) a second conductive F: SnOₓ layer.

FIG. 8A and FIG. 8B depict graphs of modeled reflectance and transmittance values versus wavelength incident an electrochromic device having material layers on the substrate, in the following order: a) a first SiOₓ layer having a thickness of 30 nm, b) a TiOₓ layer having a thickness of 20 nm, c) a second SiOₓ layer having a thickness of 30 nm, d) a first conductive F: SnOₓ layer, e) an electrochromic stack, and) a second conductive F: SnOₓ layer.

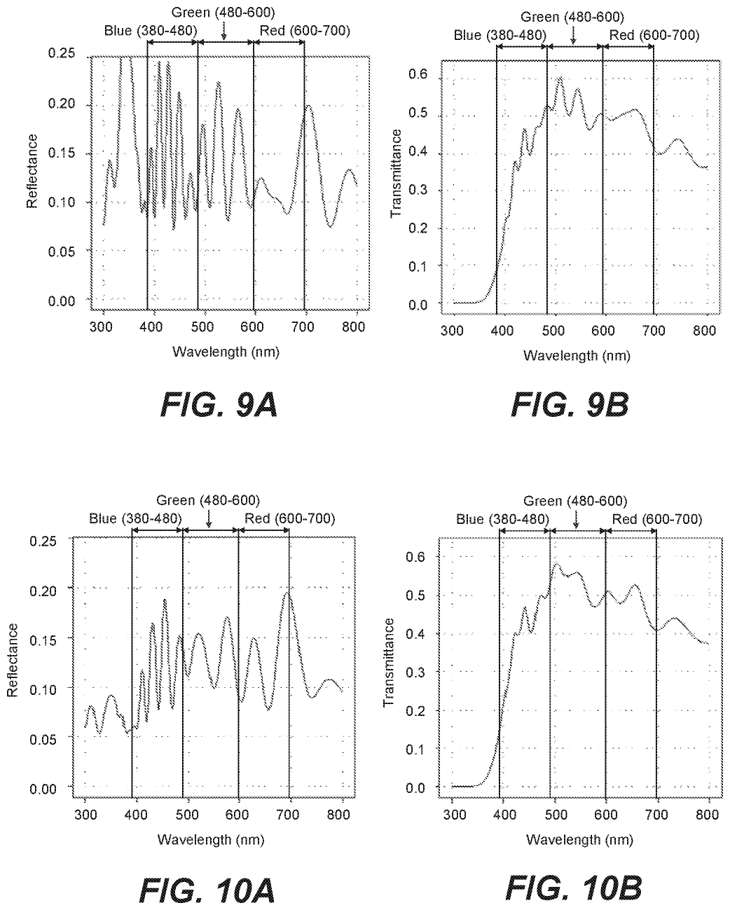

FIG. 9A and FIG. 9B depict graphs of modeled reflectance and transmittance values versus wavelength incident an electrochromic device having material layers on the substrate, in the following order: a) a first SiOₓ layer having a thickness of 30 nm, b) a Nb₂O₅ layer having a thickness of 20 nm, c) a second SiOₓ layer having a thickness of 30 nm, d) a first conductive F: SnOₓ layer, e) an electrochromic stack, and) a second conductive F: SnOₓ layer.

Generally occupants prefer reflectance of green or blue light rather than red light. The modeled reflectance values in FIG. 8A of green and blue light for an electrochromic device having an TiOₓ IM layer and the modeled reflectance values of green and blue light in FIG. 9A for an electrochromic device having an Nb₂O₅ IM layer are greater than the modeled reflectance values of green and blue light in FIG. 7A for an electrochromic device having an SnOₓ IM layer. Most particularly, the TiOₓ IM layer and the Nb₂O₅ IM layer have boosted the reflectance of blue light as compared with the SnOₓ IM layer. The increased values reflectance of blue light in the electrochromic devices using an Nb₂O₅ IM layer or a TiOₓ IM layer are preferred by occupants. These graphs show that when the high index layer SnOx is replaced with the same thickness of TiOx or Nb2O5, the color reflected off the electrochromic window shifts to more green and blue being reflected.

FIG. 10A and FIG. 10B depict graphs of modeled reflectance and transmittance values versus wavelength incident an electrochromic device having material layers on the substrate, in the following order: a) a first SiOₓ layer having a thickness of 30 nm, b) a SnOₓ layer having a thickness of 20 nm, c) a second SiOₓ layer having a thickness of 30 nm, d) a first conductive F:SnOₓ layer, e) an electrochromic stack, and) a second conductive F:SnOₓ layer.

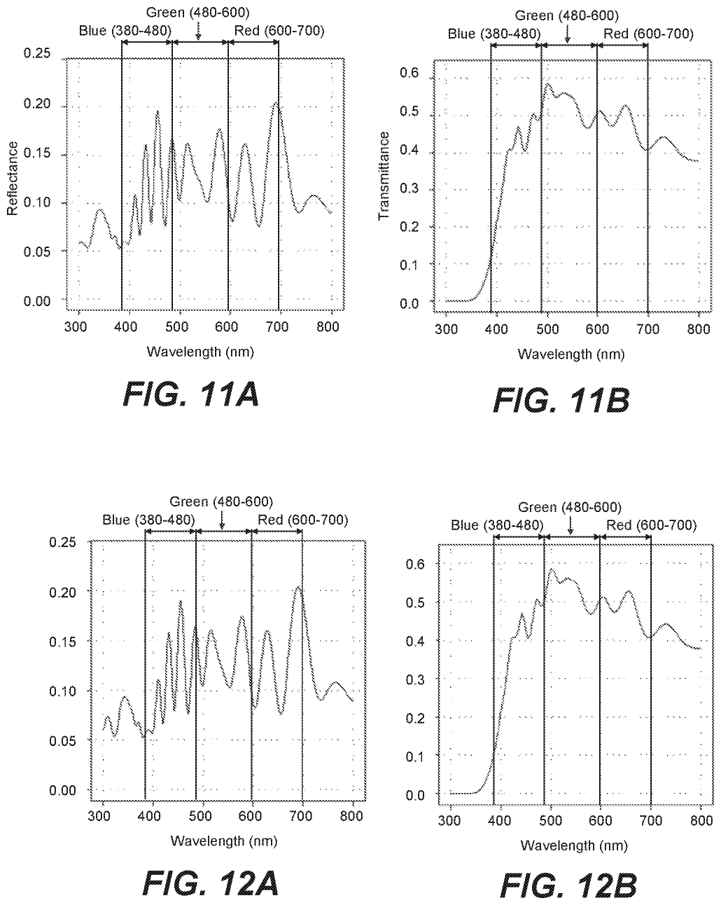

FIG. 11A and FIG. 11B depict graphs of modeled reflectance and transmittance values versus wavelength incident an electrochromic device having material layers on the substrate, in the following order: a) a first SiOₓ layer having a thickness of 30 nm, b) a TiOₓ layer having a thickness of 5 nm, c) a second SiOₓ layer having a thickness of 30 nm, d) a first conductive F:SnOₓ layer, e) an electrochromic stack, and) a second conductive F:SnOₓ layer.

FIG. 12A and FIG. 12B depict graphs of modeled reflectance and transmittance values versus wavelength incident an electrochromic device having material layers on the substrate, in the following order: a) a first SiOₓ layer having a thickness of 30 nm, b) a Nb₂O₅ layer having a thickness of 7 nm, c) a second SiOₓ layer having a thickness of 30 nm, d) a first conductive F:SnOₓ layer, e) an electrochromic stack, and) a second conductive F:SnOₓ layer.

The thickness of the TiOₓ layer in the electrochromic device associated with FIG. 11A and 11B is 5 nm. In the electrochromic devices associated with FIG. 11A, FIG. 11B, FIG. 12A, and FIG. 12B, the thickness of the IM layers of the TiOₓ layer and the Nb₂O₅ layer have been reduced and the percentage transmission values are very similar to those of the electrochromic devices associated with FIG. 8A, FIG. 8B, FIG. 9A, and FIG. 9C with greater thicknesses. These graphs show that the thicknesses of the TiOₓ IM layer and the Nb₂O₅ IM layer can be reduced. In some aspects, the TiOₓ IM layer or the Nb₂O₅ IM layer is about 6 nm. In some aspects, the TiOₓ IM layer or the Nb₂O₅ IM layer is in the range of about 5 nm and 20 nm.

B. Examples without IM Layers

In certain aspects cases, the IM layers are omitted from the intervening layers between the substrate and the first conductive layers.

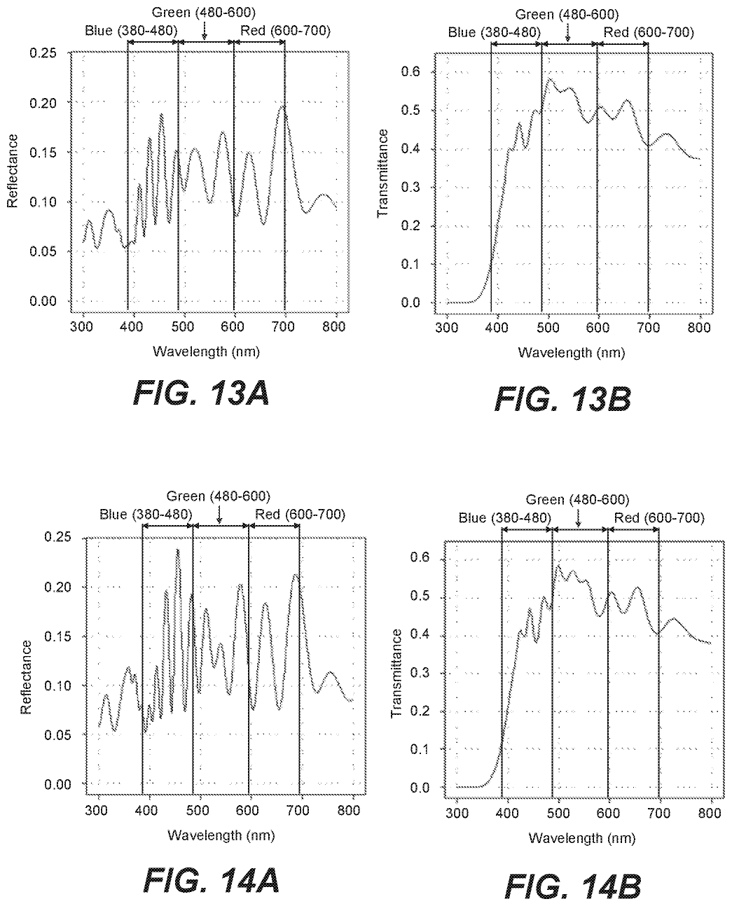

FIG. 13A and FIG. 13B depict graphs of modeled reflectance and transmittance values versus wavelength incident an electrochromic device having material layers on the substrate, in the following order: a) a first SiOₓ layer having a thickness of 30 nm, b) a SnOₓ layer having a thickness of 20 nm, c) a second SiOₓ layer having a thickness of 30 nm, d) a first conductive F:SnOₓ layer, e) an electrochromic stack, and) a second conductive F:SnOₓ layer. FIG. 14A and FIG. 14B depict graphs of modeled reflectance and transmittance values versus wavelength incident an electrochromic device having material layers on the substrate, in the following order: a) a TiOₓ layer having a thickness of 5 nm, b) a SiOₓ layer having a thickness of 30 nm, c) a first conductive F:SnOₓ layer, d) an electrochromic stack, and e) a second conductive F:SnOₓ layer. The graphs shift the color from green to pink but adjustment of the F:SnOx layer can bring this back to green. The electrochromic devices associated with FIG. 11A and 14B provide the advantages of reduced manufacturing complexity.

Planarizing Layers

Certain embodiments described herein may refer to conformal layers used in the alternative to e.g. crystalline layers that have a bumpy or rough topography, e.g. peaks and valleys that may be e.g. 50 nm or more in height/depth. In certain embodiments, planarizing layers are used to negate the effect of this topography on layers deposited on top of the rough layer. A planarizing layer, as used herein, is a layer or material that has an upper surface with a surface roughness less than the surface roughness of the upper surface of an underlying layer or material on which the layer or material is deposited, applied, formed, or otherwise disposed on or over. In some embodiments, a planarizing layer has an upper surface with a surface roughness of about one half or less, one third or less, or one quarter or less, of the surface roughness of the upper surface of the underlying layer. Surface roughness can be quantified by one of the standard parameters for surface roughness, including Rₐ which is the arithmetic average of the absolute values of the peak-to-valley heights, and Rᵣₘₛ which is the square root of the mean of the squares of the peak-to-valley heights. Planarizing layers may be deposited or otherwise formed via dip coating, spin coating, inkjet printing, roll coating, spray coating, PVD, CVD, spray pyrolysis, meniscus coating, sol-gel and the like using the layer or material in final form or e.g. solution-based precursors which are converted to the final material e.g. by baking at between about 40C and about 400C. Planarizing layers may be any materials described herein in relation to embodiments of the invention, e.g. as described for conformal layers.

In some cases, the glass is pre-fabricated with the first conductor layer and the intervening layers on the substrate. In these cases, the electrochromic stack and the second conductive layer are deposited on the glass with the pre-fabricated layers.

Although the foregoing disclosed embodiments have been described in some detail to facilitate understanding, the described embodiments are to be considered illustrative and not limiting. It will be apparent to one of ordinary skill in the art that certain changes and modifications can be practiced within the scope of the appended claims.

One or more features from any embodiment may be combined with one or more features of any other embodiment without departing from the scope of the disclosure. Further, modifications, additions, or omissions may be made to any embodiment without departing from the scope of the disclosure. The components of any embodiment may be integrated or separated according to particular needs without departing from the scope of the disclosure.

What is claimed is:

1. An electrochromic device comprising, in the following order:
a substantially transparent substrate;
a stack of interleaved index matching layers including a first index matching layer and a second index matching layer, the first index matching layer having a higher refractive index than the second index matching layer;
a first conductive layer;
a solid state and inorganic electrochromic stack; and
a second conductive layer.

2. The electrochromic device of claim 1, wherein the first index matching layer is a TiOₓ material layer or an Nb₂O₅ material layer.

3. The electrochromic device of claim 2, wherein the second index matching layer is a silicon oxide layer.

4. The electrochromic device of claim 1, further comprising a diffusion barrier layer.

5. The electrochromic device of claim 4, wherein the diffusion barrier layer is located between the substantially transparent substrate and the first index matching layer.

6. The electrochromic device of claim 5, wherein the diffusion barrier layer is a silicon oxide layer.

7. The electrochromic device of claim 1, wherein each of the first and second conductive layers is a transparent conductive oxide layer.

8. The electrochromic device of claim 1, wherein each of the first and second conductive layers is a one of a fluorinated tin oxide (FTO) layer, an indium tin oxide (ITO) layer, and an aluminum zinc oxide (AZO) layer.

9. The electrochromic device of claim 1 or 3, wherein the second index matching layer has a thickness in a range of about 20 nm to about 30 nm.

10. The electrochromic device of claim 1, wherein the first index matching layer is a transparent material having a refractive index of greater than about 2.2.

11. The electrochromic device of claim 1, wherein the first index matching layer is a transparent material having a refractive index in a range of about 2.2 to about 2.7.

12. The electrochromic device of claim 1 or 2, wherein the first index matching layer has a thickness in a range of about 5 nm and about 7 nm.

13. The electrochromic device of claim 1 or 2, wherein the first index matching layer has a thickness in a range of between 5 nm and 20 nm.

14. The electrochromic device of any of claims 1-13, wherein the substantially transparent substrate is soda lime glass.

15. The electrochromic device of any of claims 1-14, further comprising one or more defect mitigating insulating layers.

16. An electrochromic device comprising, in the following order;
a substantially transparent substrate;
a diffusion barrier layer;
a TiOₓ material layer or a Nb₂O₅ material layer;
a first conductive layer;
a solid state and inorganic electrochromic stack; and
a second conductive layer.

17. The electrochromic device of claim 16, wherein each of the first and second conductive layers is a transparent conductive oxide layer.

18. The electrochromic device of claim 17, wherein each of the first and second conductive layers is one of a fluorinated tin oxide (FTO) layer, an indium tin oxide (ITO) layer, and an aluminum zinc oxide (AZO) layer.

19. The electrochromic device of claim 17 or 18, wherein the substantially transparent substrate is soda lime glass.

20. The electrochromic device of any of claims 17-19, further comprising one or more defect mitigating insulating layers.
